(19) United States
(12) Patent Application Publication
(10) Pub. No.: US 2008/0197188 A1
(43) Pub. Date: Aug. 21, 2008

(54) TRANSMISSION AND CAPTURE OF LINE-ITEM-DETAIL TO ASSIST IN TRANSACTION SUBSTANTIATION AND MATCHING

(75) Inventors: Jason Jagatic, Hoboken, NJ (US); Sarah Harrison, New York, NY (US); Margaret A. Miller, Land O' Lakes, FL (US); Sunil Sachdev, New Rochelle, NY (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 11/675,478

(22) Filed: Feb. 15, 2007

(51) Int. Cl. G06K 7/00

(52) U.S. Cl. 235/380

(57) ABSTRACT

A system, method and computer program product for capturing Line-Item-Detail to assist in substantiating eligible expenses for participating card holders. The system leverages existing data feeds to capture Line-Item-Detail at a point of sale (POS). Advanced filtering and transmission protocols are implemented to enable the process of capturing and transmission of data. The system helps to reduce the number of paper receipts that are required from card members, especially those resulting from over the counter purchases at retail stores. By flagging eligible purchases, the invention aids in automation of the rebate/claims process thereby leading to a faster rebate process and hence, improving customer satisfaction.

### BACKGROUND OF THE INVENTION

1. Field of the Invention

The present invention generally relates to the field of transmission and capture of line-item detail to assist in transaction substantiation and matching.

2. Related Art

According to currently effective IRS guidelines, various items like “over the counter” (OTC) items, for example, are deemed eligible for benefits under tax advantaged accounts like Flexible Savings Account (FSA) or Health Reimbursement Account (HRA) for a card holder. In a traditional approach a card holder first pays full price for all items bought over the counter followed by submitting a paper based claims form to an administrator. The administrator can be a third party administrator or in some cases, an employer. In case of a third party administrator, the administrator administers a healthcare plan on behalf of the employer. Following an eligibility determination, the administrator would then reimburse the card holder for eligible claims. This process while being time consuming and resource intensive, is at the same time prone to a multitude of errors, like data entry errors.

The IRS has also recently allowed certain healthcare items to be deemed eligible for Health Savings Account (HSA) benefits. Unlike the FSA or the HRA however, an individual card holder is responsible for ensuring that the amount allocated to an HSA account is spent particularly on eligible spending. This again results in a lot of erroneous purchases leading to potential audit issues with the IRS and financial losses.

Some specific merchants, like Walgreens of Dixon, Ill., have attempted to implement similar concepts in the past. However, these approaches have been proprietary and limited to their own systems. That is, there is no integration between many vendors offering OTC items to the same customer. Further still, they do not take into account an integration of different outlets that a card holder may go to and purchase items eligible for benefits under tax advantaged accounts.

Given the foregoing, what is needed is a system, method and computer program product for carrying out a capture and transmission of specific line-item-details, triggered by a purchase made by a card holder at a point of sale, that automatically provides for substantiation for tax advantaged account related purchases. Further, the system, method and computer program product should be able to address security issues associated with such an instantaneous capture and transmission by encrypting card numbers and matching them with eligible card numbers from a database, dynamically in real time or offline (or batch mode).

### SUMMARY OF THE INVENTION

The present invention meets the above-mentioned needs by providing a system, method and computer program product capturing line-item-detail (LID) to assist in substantiating eligible expenses for participating card holders. The process leverages existing data feeds to capture LID at a point of sale (POS) terminal. The POS terminal sends the encrypted LID to a central database to match up with card holder information and his or her eligibility to use tax advantaged account funds for that purchase.

Various embodiments of the present invention provide a system, method and computer program product for capturing, in a secure way, line-item-detail (LID) to assist in substantiating eligible expenses for participating card holders. The various embodiments may also include performing one or more of the aforementioned functions independently and in any order, as per the need.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings, in which like reference numbers indicate identical or functionally similar elements. Additionally, the left-most digit of a reference number identifies the drawing in which the reference number first appears.

FIG. 1 illustrates a sample receipt containing line-item-details for a purchase made by a card holder, according to one embodiment of the invention;

FIG. 2 is an exemplary environment in which an embodiment of the invention may be implemented;

FIG. 3 is a flowchart illustrating a process of capture and transmission of line-item-detail to provide tax advantaged account benefits for eligible items to card holders;

FIG. 4 is a block diagram of an exemplary computer system useful for implementing the present invention.

### DETAILED DESCRIPTION

### I. Overview

The detailed description of exemplary embodiments of the invention herein makes reference to the accompanying drawings and figures, which show the exemplary embodiments by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. It will be apparent to a person skilled in the pertinent art that this invention can also be employed in a variety of other applications. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional aspects of the systems (and components of the consumer operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present invention is directed to a system, method and computer program product for providing eligible card holders with access to funds in tax advantaged accounts, based on purchases made by them by capturing the line-item-details. The captured line-item-details are transmitted to various databases to determine the eligibility of captured line-item-details for benefits under tax advantaged accounts. Further, the present invention seeks to perform encryption and decryption of all data items during transmission. It is also contemplated that matching operations be performed only for card holders eligible for benefits under tax advantaged accounts will be performed on a real time or offline (batch) basis over a full-duplex communication channel.

It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The present invention is now described in more detail herein in terms of the above exemplary system, method and computer program product. This is for convenience only and is not intended to limit the application of the present invention. In fact, after reading the following description, it will be apparent to one skilled in the relevant art(s) how to implement the following invention in alternative embodiments.

### II. System

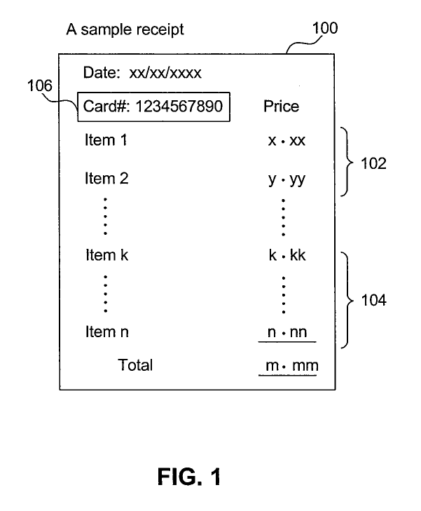

FIG. 1 shows parts of a sample receipt 100 obtained when a card holder makes a purchase of items. Sample receipt 100 may also contain, for example, other merchandise not related to a card holder's healthcare, tax advantaged account. As shown in FIG. 1, sample receipt 100 contains, amongst other data items, a card number 106, items 102 and items 104. For example and not by way of limitation, items 102 may be items that are eligible for use of funds in tax advantaged accounts whereas items 104 are merchandise items which do not qualify for tax advantage benefits per IRS guidelines.

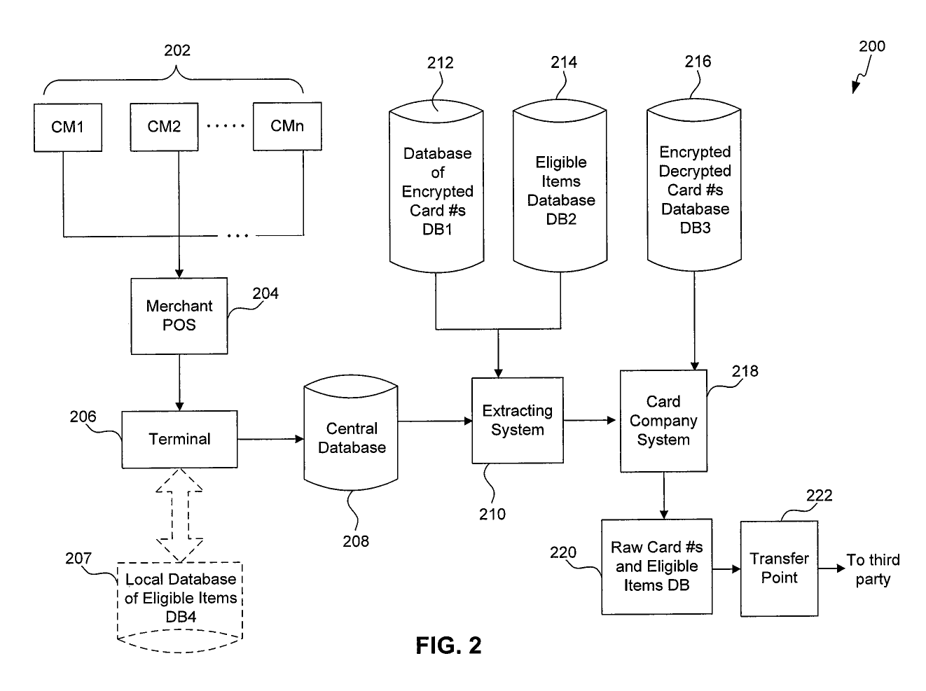

According to one embodiment of the invention, a card holder for whom sample receipt 100 is generated will be automatically substantiated for items 102. In other words, the card holder will not have to file paper based claims. Further, the process by which data in sample receipt 100 is sent to central database 208 (shown in FIG. 2) involves encryption of information contained in sample receipt 100 and any other information relevant to a card member for whom sample receipt 100 might be generated. It should be noted that sample receipt 100 shown in FIG. 1 can be in hardware or software form and its actual presentation format may vary for different embodiments of the present invention.

FIG. 2 shows an exemplary environment in which a system 200, according to an embodiment of the present invention, may be implemented. FIG. 2 shows a card holder group 202 (also referred to as card holder 202) having one or more card members CM1, CM2, . . . , CMn. Card holder 202 may purchase items at a merchant on whose premises a merchant POS 204 may be installed. Although system 200 shows only one merchant POS 204, more than one such merchant POS can be easily contemplated by those skilled in the art. Therefore, the following description of a single merchant POS 204 is at least equally applicable to more than one merchant POSs. Merchant POS 204 can read data corresponding to card holder 202 by means of a wedge card reader, for example and not by way of limitation. Merchant POS 204 is coupled locally to a terminal 206. Terminal 206 can be, for example and not by way of limitation, a local database of any type described below in this specification. Further, terminal 206 can have a local database of eligible items (DB4) as shown by the dotted box 207. In a real time communication between merchant POS 204 and terminal 206, depending on specific security needs and available infrastructure, encryption may or may not be performed.

In an exemplary batch processing mode, terminal 206 will encrypt data presented by card holder 202 to merchant POS 204. Encryption of data can be carried out using standard techniques, for example RSA algorithm or DEC algorithm. Card holder 202 can present data to merchant POS in various forms, for example a magnetic card, a radio frequency identification (RFID) card, a chip card or any other form easily contemplated by one skilled in the art. Further, terminal 206 can have, for example, means to collect data for instantaneous or future marketing purposes. Merchant POS 204 can also be a virtual POS, as might be the case in an online purchase made by card holder group 202.

Terminal 206 is connected to a central database 208 that contains, amongst other data, stock keeping unit (SKU) data and encrypted card numbers from various card holders of card holder group 202.

Merchant POS 204 can communicate with terminal 206 by means of a communication path. In a scenario where substantially real time data updates are taking place at local databases connected to merchant POS 204 (not shown in system 200), terminal 206 can communicate in a full duplex manner with merchant POS 204. Terminal 206 obtains updated data from central database 208 corresponding to purchases made by card holder 202, and passes it on a full duplex path to merchant POS 204 to provide benefits to card holder group 202.

Central database 208 passes SKU data and encrypted card numbers data obtained from all card holders of card holder group 202 to an extracting system 210. It should be noted that central database 208 could also be further connected to multiple terminals similar to terminal 206. Extracting system 210 further receives its inputs from a database 212 and an eligible items database 214. Based on the inputs from eligible items database 214, extracting system 210 extracts items eligible for FSA or HSA benefits. Extracting system 210 also searches the SKU data in central database 208 to extract all transactions related to all encrypted card numbers (that belong to different members of card holder group 202). All such card numbers are held in unique accounts by a card company system 218, which is also connected to extracting system 210. Extracting system 210 matches extracted data from central database 208 and database 212 with entries extracted from eligible items database 214. Once the matching is complete, extracting system 210 sends a file of encrypted card numbers and eligible SKUs to card company system 218. As is well known to one skilled in the art, the file generated could be in standard format like .doc, .pdf or other.

A card company system 218 is linked to a database 216 including a table of encrypted and decrypted card numbers. Card company system 218 uses data from database 216 to create a raw data format including, for example, card numbers that are not in an encoded format. These card numbers are sent to a raw card numbers and eligible items database 220 which, on a periodic or random basis, sends data out to third parties for substantiation via a transfer point 222. Such third parties may include, for example, various third party administrators and associated systems. Transfer point 222 can be a switch or a hub, or any other bridging device well known to one skilled in the art. Further, transfer point 222 could be implemented in hardware, software or an appropriate combination of both, as is also well known to one skilled in the art.

In general, system 200 can be implemented as a mix of hardware or software components, well known to those skilled in the art.

### III. Process

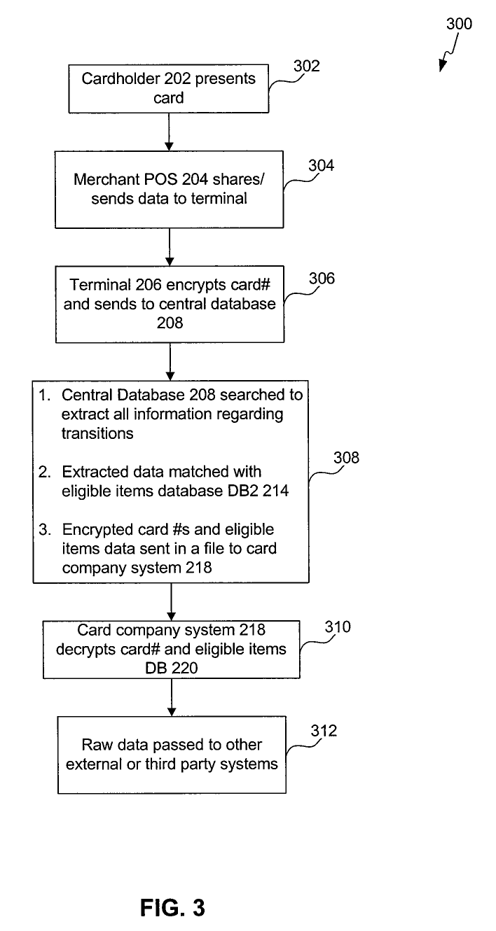

FIG. 3 is a flowchart illustrating a process 300 of capturing and transmitting a line-item-detail for substantiating purchases for benefits associated with tax advantaged accounts of card holders of card holder group 202.

In step 302, card holder 202 presents a card at merchant POS 204. Merchant POS 204 reads data stored in the card through a card reading device, like a wedge card reader.

In step 304, merchant POS 204 sends data to terminal 206. In step 306, terminal 306 encrypts the data and further transmits it to central database 108, in an encrypted format.

In step 308, extracting system 210 searches for information regarding all transactions made by card holder group 202. The extracted data is then matched with entries in an eligible items database 214. Further, in step 308, encrypted card numbers obtained from database 212 and eligible items data are sent in a file to card company system 218 for processing.

In step 310, card company system 218 decrypts card numbers and eligible items data to a raw data format.

In step 312, raw data from step 310 is then passed to third party affiliates for substantiation, if needed.

It should be noted that steps 302-312 do not necessarily have to be followed in a particular order for the invention to work and are described above for illustrative purposes only.

Any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the present invention, any suitable data storage technique may be utilized to store data without a standard format. Data sets may be stored using any suitable technique, including, for example, storing consumer files using an ISO/IEC 7414-4 file structure; implementing a domain whereby a dedicated file is selected that exposes one or more elementary files containing one or more data sets; using data sets stored in consumer files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7414-6 data elements; stored as ungrouped data elements encoded using ISO/IEC Abstract Syntax Notation (ASN.1) as in ISO/IEC 8428 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial payment instrument or external to but affiliated with the financial payment instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial payment instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of the present invention, the data can be stored without regard to a common format. However, in one exemplary embodiment of the present invention, the data set (e.g., BLOB) may be annotated in a standard manner when provided for manipulating the data onto the financial payment instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain consumers, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the payment instrument user at the stand alone device, the appropriate option for the action to be taken. The present invention may contemplate a data storage arrangement wherein the header or trailer, or header or trailer history, of the data is stored on the payment instrument in relation to the appropriate data.

One skilled in the art will also appreciate that, for security reasons, any databases, systems, devices, servers or other devices of system 200 may consist of any combination thereof at a single location or at multiple locations, wherein each database or system includes any of various suitable security features, such as firewalls, access codes, encryption, decryption, compression, decompression, and/or the like.

System 200 may be described herein in terms of functional block components and various processing steps. It should be appreciated that such functional blocks may be realized by any number of hardware and/or software components configured to perform the specified functions. For example, system 200 may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, system 200 may be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, system 200 may be embodied as a customization of an existing system, an add-on product, upgraded software, a stand-alone system, a distributed system, a method, a data processing system, a device for data processing, and/or a computer program product. Accordingly, system 200 may take the form of an entirely software embodiment, an entirely hardware embodiment, or an embodiment combining aspects of both software and hardware. Furthermore, system 200 may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

### IV. Example Implementations

The present invention (i.e., system 200, process 300 or any part(s) or function(s) thereof) may be implemented using hardware, software or a combination thereof, and may be implemented in one or more computer systems or other processing systems. However, the manipulations performed by the present invention were often referred to in terms, such as comparing or checking, which are commonly associated with mental operations performed by a human operator. No such capability of a human operator is necessary, or desirable in most cases, in any of the operations described herein, which form a part of the present invention. Rather, the operations are machine operations. Useful machines for performing the operations in the present invention may include general-purpose digital computers or similar devices.

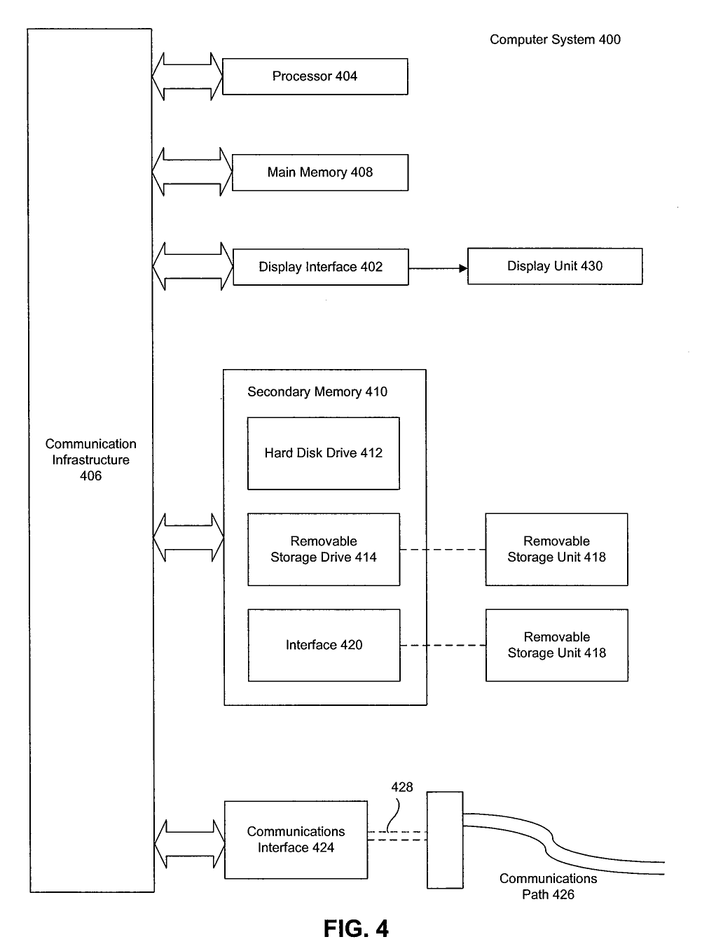

In fact, in accordance with an embodiment of the present invention, the present invention is directed towards one or more computer systems capable of carrying out the functionality described herein. An example of the computer systems includes a computer system 400, which is shown in FIG. 4.

Computer system 400 includes one or more processors, such as a processor 404. Processor 404 is connected to a communication infrastructure 406, for example, a communications bus, a cross over bar, a network, and the like. Various software embodiments are described in terms of this exemplary computer system 400. After reading this description, it will become apparent to a person skilled in the relevant art(s) how to implement the present invention using other computer systems and/or architectures.

Computer system 400 includes a display interface 402 that forwards graphics, text, and other data from communication infrastructure 406 (or from a frame buffer which is not shown in FIG. 4) for display on a display unit 430.

Computer system 400 also includes a main memory 408, such as random access memory (RAM), and may also include a secondary memory 410. Secondary memory 410 may include, for example, a hard disk drive 412 and/or a removable storage drive 414, representing a floppy disk drive, a magnetic tape drive, an optical disk drive, etc. Removable storage drive 414 reads from and/or writes to a removable storage unit 418 in a well known manner. Removable storage unit 418 represents a floppy disk, magnetic tape, optical disk, and the like. Removable storage unit 418 may be read by and written to by removable storage drive 414. As will be appreciated, removable storage unit 418 includes a computer usable storage medium having stored therein, computer software and/or data.

In accordance with various embodiments of the present invention, secondary memory 410 may include other similar devices for allowing computer programs or other instructions to be loaded into computer system 400. Such devices may include, for example, a removable storage unit such as removable storage unit 418, and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from removable storage unit 418 to computer system 400.

Computer system 400 may also include a communication interface 424. Communication interface 424 allows software and data to be transferred between computer system 400 and external devices. Examples of communication interface 424 may include a modem, a network interface (such as an Ethernet card), a communications port, a Personal Computer Memory Card International Association (PCMCIA) slot and card, and the like. Software and data transferred via communication interface 424 are in the form of a plurality of signals, hereinafter referred to as signals 428, which may be electronic, electromagnetic, optical or other signals capable of being received by communication interface 424. Signals 428 are provided to communication interface 424 via a communication path (e.g., channel) 426. Communication path 426 carries signals 428 and may be implemented using wire or cable, fiber optics, a telephone line, a cellular link, a radio frequency (RF) link and other communication channels.

In this document, the terms “computer program medium” and “computer usable medium” are used to generally refer to media such as removable storage drive 414, a hard disk installed in hard disk drive 412, signals 428, and the like. These computer program products provide software to computer system 400. The present invention is directed to such computer program products.

Computer programs (also referred to as computer control logic) are stored in main memory 408 and/or secondary memory 410. Computer programs may also be received via communication interface 424. Such computer programs, when executed, enable computer system 400 to perform the features of the present invention, as discussed herein. In particular, the computer programs, when executed, enable processor 404 to perform the features of the present invention. Accordingly, such computer programs represent controllers of computer system 400.

In accordance with an embodiment of the present invention, where the present invention is implemented using software, the software may be stored in a computer program product and loaded into computer system 400 using removable storage drive 414, hard disc drive 412 or communication interface 424. The control logic (software), when executed by processor 404, causes processor 404 to perform the functions of the present invention as described herein.

In another embodiment, the present invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the present invention is implemented using a combination of both the hardware and the software.

### V. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

1. A method for automatically providing a tax-benefit for eligible purchases by capturing line item data related to items being purchased, comprising:
(a) reading data from a customer account card, in connection with a process for payment by a customer for the items being purchased, at a point of sale device;
(b) sending data read from the card and line item data related to the items being purchased to a database remote from the point of sale device;
(c) comparing the line item data with a list of items stored in the database that are eligible for a tax-benefit and generating tax-benefit eligible data identifying any items from amongst those being purchased that are eligible for a tax benefit;
(d) sending the tax-benefit eligible data to the point of sale device;
(e) processing payment information for the purchased items taking into account any eligible tax benefits: and
(f) displaying information related to eligible tax-benefits, at the point of sale device, in real time.

2. The method of claim 1, wherein step (b) comprises encrypting data being sent to the database according to an RSA algorithm.

3. The method of claim 1, wherein data being sent to the database and data being received from the database are transmitted using full duplex communication.

4. The method of claim 1, wherein the data stored on the card is encrypted and the method further comprises comparing encrypted data read from the card with a table of encrypted card numbers.

5. The method of claim 1, wherein step (d) comprises decrypting data received at the point of sale device according to an RSA algorithm.

6. The method of claim 1, further comprising: transmitting the payment information to a third party.

7. A system for automatically providing a tax-benefit for an eligible purchase by capturing line item data from a list of purchased items, comprising:
a point of sale device configured to read data from a customer account card;
a first database associated with the point of sale device;
a second database comprising at least one table of encrypted card numbers and a list of eligible items associated customer accounts;
means for identifying, at the second database, one or more eligible items, among the items being purchased, that are eligible for a for tax-benefit; and
means for sending data related to the identified one or more eligible items to the point-of sale device, whereby tax-benefits are provided in real-time for the identified one or more eligible items.

8. The system of claim 7, wherein the data read from the customer account card is enerypted according to an RSA algorithm.

9. The system of claim 7, wherein the first local database contains healthcare and financial information related to a customer account.

10. A computer readable storage medium having computer program code recorded thereon, that when executed by a processor causes the processor automatically provide tax-benefits for eligible purchases by capturing line item data related to items being purchased, the computer program code comprising:
a first set of instructions for reading data from a customer account card at a point of sale device in connection with a process for a payment of the items being purchased by a customer;
a second set of instructions for sending the read data to a database remote from the point of sale device;
a third set of instructions for searching purchases eligible for the tax-benefits, amongst the purchased items;
fourth set of instructions for sending information related to the purchases eligible to the point-of sale device and separately to a card company for storage purposes; and
a fifth set of instructions for processing payment information for the purchased items, and for displaying the tax benefits on an item-by-item basis at the point-of-sale device in real-time for the eligible purchases, amongst the purchased items.

11. The method of claim 1, further comprising:
(g) updating a local database at the point of sale device for most recent prices of the purchased items.
